(19) United States
(12) Patent Application Publication
(10) Pub. No.: US 2002/0101559 A1
(43) Pub. Date: Aug. 1, 2002

(54) OPTICAL LOW-PASS FILTER AND METHOD FOR PRODUCING THE SAME AND IMAGE PICK-UP APPARATUS AND METHOD FOR PRODUCING THE SAME

(76) Inventor: MITSUYOSHI ICHIHASHI, SHIZUOKA (JP)

Correspondence Address: SUGHRUE MION ZINN MACPEAK & SEAS PLLC, 2100 PENNSYLVANIA AVENUE N W, WASHINGTON, DC, 200373202

(21) Appl. No.: 09/293,984

(22) Filed: Apr. 19, 1999

(30) Foreign Application Priority Data
Apr. 17, 1998 (JP) P.HEI10-107992

(51) Int. Cl. G02F 1/13

(52) U.S. Cl. 349/193

(57) ABSTRACT

An optical low-pass filter comprising a cured film of a liquid crystal compound having an average optical axis oriented at a predetermined angle with respect to a boundary surface. Further, the cured film of the liquid crystal compound is provided as a film having a thickness no less than 10 μm. The optical low-pass filter has optical characteristic equivalent to that of crystal and is reduced both in size and in cost.

### BACKGROUND OF THE INVENTION

1. Field of the Invention

The present invention relates to an optical low-pass filter having birefringent polarization characteristic, a method for producing the same, an image pick-up apparatus having such an optical low-pass filter and a method for producing the same.

2. Description of the Related Art

In most image pick-up apparatuses inclusive of CCD image pick-up apparatuses, optical low-pass filters are heretofore used for preventing generation of moire.

Typical examples of such an optical low-pass filter include a lenticular micro-lens, a phase plate (noise filter), a phase type diffraction grating, an artificial crystal, etc. A lenticular micro-lens has a small optical path length and has a past record of practical use for many years. A phase plate (noise filter) also has a small optical path length and has a feature that it can be disposed freely. A phase type diffraction grating also has a small optical path length and has a feature that not only it can be disposed freely but also the cost of producing it can be suppressed low. An artificial crystal has a feature that not only various characteristics can be achieved in accordance with the way of bonding the artificial crystal but also the performance of the artificial crystal is stable. Having a problem of their large optical path length for optical low-pass filters. artificial crystals are used in most of the image pick-up apparatuses in recent years because of their special characteristics mentioned above.

There have been problems as follows in such an optical low-pass filter made of a crystal.

FIG. 2 is an explanatory view showing the optical characteristic of a crystal optical low-pass filter used heretofore.

In the case where crystal is used as an optical low-pass filter, a phenomenon is utilized in which incident light is split into an ordinary ray and an extraordinary ray so that the ordinary ray and the extraordinary ray go out parallelly with the same light intensity to thereby form a double image. In this case, the angle θ between the ordinary ray and the extraordinary ray is a deciding factor for obtaining a distance required for operating the crystal as an optical low-pass filter between the ordinary ray and the extraordinary ray. The larger the refractivity anisotropy, the large this angle θ. Quartz has the largest value of refractivity anisotropy in crystals, but even in quartz, this value is low so as to be no more than 0.009. This causes the optical path length to be large.

Further, production steps such as polishing of crystal, and so on, are required. Accordingly, crystal is unsuitable for mass production. In addition. when quartz is used, there is also a problem that raw materials per se are expensive.

### SUMMARY OF THE INVENTION

The present invention is intended to solve the problems in the optical low-pass filters in the background art.

A first object of the present invention is to provide a small-size and low-cost optical low-pass filter which has optical characteristic equivalent to that of crystal.

A second object of the present invention is to provide a method for producing the optical low-pass filter described in the first object.

A third object of the present invention is to provide an image pick-up apparatus which is integrated with the optical low-pass filter described in the first object.

In order to achieve the first object, according to an aspect of the present invention, provided is an optical low-pass filter comprising a cured film of a liquid crystal compound having an average optical axis oriented at a predetermined angle with respect to a boundary surface.

Preferably, said cured film of said liquid crystal compound is formed, as a film having a thickness no less than 10 μm, on a transparent or semitransparent substrate or between transparent or semitransparent substrates using at least glass or plastics as a raw material.

Preferably, said liquid crystal compound is formed by use of a compound having a photo- or thermo-crosslinkable group at a molecule terminal.

In order to achieve the second object, according to another aspect of the present invention, provided is a method for producing an optical low-pass filter, comprising the steps of: forming an oriented film having a predetermined orientation form on a transparent or semitransparent substrate using at least glass or plastics as a raw material; depositing a liquid crystal compound as a film having a thickness no less than 10 μm onto said substrate or between a pair of substrates; and curing said deposited liquid crystal compound while keeping it birefringent to thereby produce a cured-film optical low-pass filter.

In order to achieve the third object, according to a further aspect of the present invention, provided is an image pick-up apparatus comprising: a matrix image pick-up device; a transparent cover covering a light-input portion of said image pick-up device; and a cured film of a liquid crystal compound disposed on said transparent cover so that an average optical axis is oriented at a predetermined angle with respect to a boundary surface of said transparent cover.

An example of the matrix image pick-up device is a CCD image pick-up device.

Preferably, said transparent cover uses at least glass or plastics as a raw material; and said cured film of said liquid crystal compound is provided, as a film having a thickness no less than 10 μm, on said transparent cover.

Preferably, said liquid crystal compound is formed by use of a compound having a photo- or thermo-crosslinkable group at a molecule terminal.

According to a still further aspect of the present invention, provided is a method for producing an image pick-up apparatus, comprising the step of forming a cured film of a liquid crystal compound on a transparent cover covering a light-input portion of a matrix image pick-up device in the condition that an average optical axis is oriented at a predetermined angle with respect to a boundary surface of said transparent cover.

According to a still further aspect of the present invention, provided is a method for producing an image pick-up apparatus, comprising the steps of: forming a cured film of a liquid crystal compound on a transparent cover in the condition that an average optical axis is oriented at a predetermined angle with respect to a boundary surface said transparent cover; and disposing said transparent cover in a light-input portion of a matrix image pick-up device.

An optical filter layer or a semiconductor layer may be used as the substrate for the optical low-pass filter.

Low-molecular liquid crystal, discotheque liquid crystal, chiral liquid crystal, or the like, may be used as the liquid crystal for the optical low-pass filter.

At least one means selected from the group consisting of a perpendicular orientation means using a silane coupling agent, an orientation means using rubbing after application of a high-molecular film using at least polvimide or PVA as a raw material. an optical orientation means using polarized UV radiation, an orientation means using sputtering, a flow orientation means using shearing stress, an orientation means using oblique vapor deposition of an inorganic matter, and all other orientation means used for orientation of crystal, may be used as the oriented film-forming means in production of the optical low-pass filter.

At least one means selected from a UV radiation means and a heating means may be used as the means for fixing the liquid crystal.

The operation of the optical low-pass filter according to the present invention will be described below.

In the optical low-pass filter according to the present invention, the same theory as that in an optical low-pass filter using crystal can be utilized, so that the same characteristic as that in the optical low-pass filter using crystal can be obtained. Because the refractivity anisotropy of liquid crystal exhibits a large value of from 0.15 to 0.30, the optical path length, that is, filter thickness can be reduced while the optical low-pass filter according to the present invention has the same characteristic as that in the optical low-pass filter of crystal. Further, not only the liquid crystal material is much cheaper than crystal but also the process of production of the liquid crystal is simpler. Accordingly, a low-cost optical low-pass filter can be provided.

In addition, when a CCD image pick-up apparatus using the optical low-pass filter is formed, space in front of a CCD image pick-up device as required for the background art-type optical low-pass filter can be almost eliminated. Accordingly, the greater reduction of the size of the image pick-up apparatus can be achieved.

### BRIEF DESCRIPTION OF THE DRAWINGS

FIGS. 1A to 1D are explanatory views showing structures of optical low-pass filters according to embodiments of the present invention in four forms of liquid crystal molecules; and

FIG. 2 is an explanatory view showing the optical characteristic of an optical low-pass filter of crystal used in the background art.

### DESCRIPTION OF THE PREFERRED EMBODIMENTS

Embodiments of the present invention will be described below with reference to the drawings.

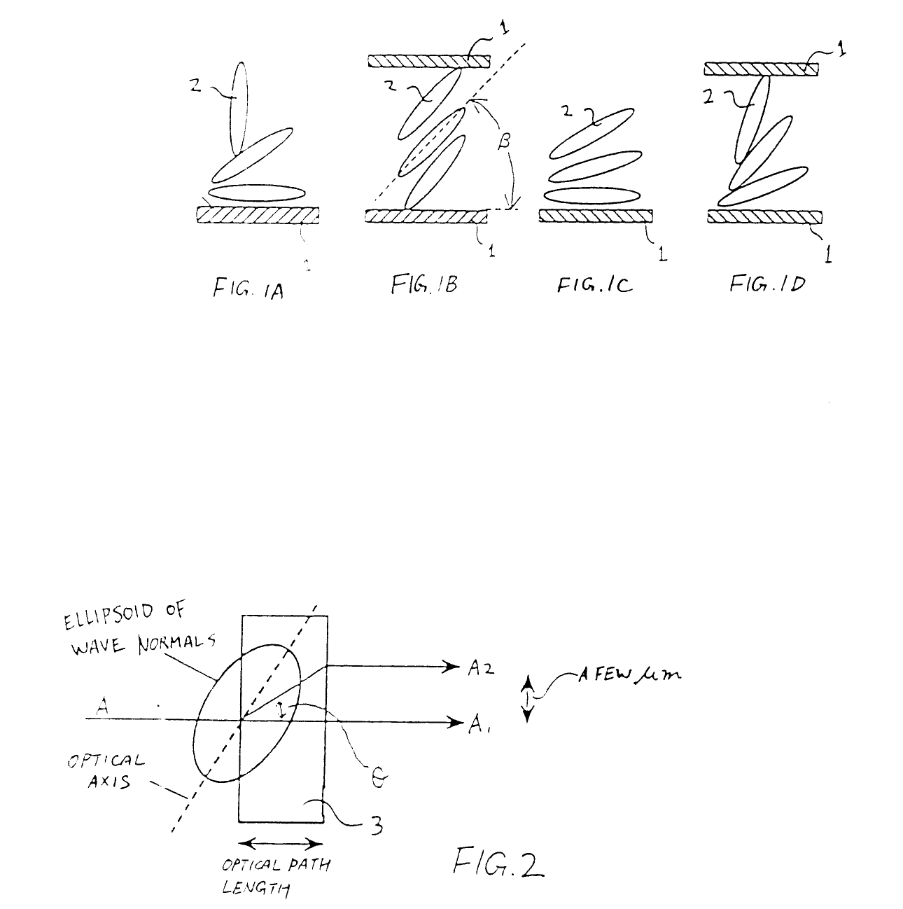

FIGS. 1A to 1D are explanatory views showing the structures of optical lowpass filters according to various embodiments of the present invention in four forms of liquid crystal molecules, respectively.

In each of FIGS. 1A to 1D, liquid crystal molecules 3 are oriented in a predetermined direction and fixed on a plane of a substrate 1.

In the embodiment shown in FIG. 1A, there are provided, in mixture, a liquid crystal molecule 3 having an optical axis oriented so as to be perpendicular to a surface of a substrate 1, a liquid crystal molecule 3 having an optical axis oriented so as to be oblique to the surface of the substrate 1 and a liquid crystal molecule 3 having an optical axis oriented so as to be parallel with the surface of the substrate 1. The angle (tilt angle) between the optical axis of the liquid crystal molecule 3 and the surface of the substrate I is preferably selected to be in a range of from 30 degrees to 60 degrees. The optimum angle is 50 degrees.

In the embodiment shown in FIG. 1B, each of liquid crystal molecules 3 is oriented so that the angle between the optical axis of each liquid crystal molecule 3 and the surface of the substrate 1 is made to be a predetermined angle β (about 50 degrees). FIG. 1B shows optimum functional characteristic.

In the embodiment shown in FIG. 1C, the angle of the optical axis of each of liquid crystal molecules 3 with respect to the surface of the substrate 1 is made to be equal to or smaller than 45 degrees. Such optimum functional characteristic as that in the optical low-pass filter shown in the embodiment of FIG. 1B is not exhibited in this embodiment but a filter layer can be made thin. The optical path length is, however, larger than that of the optical low-pass filter in the embodiment shown in FIG. 1B.

In the embodiment shown in FIG. 1D, some of liquid crystal molecules 3 may have the angle of its optical axis which is made to be no less than 45 degrees with respect to the surface of the substrate 1.

A transparent or semitransparent substrate of glass, plastics, or the like, may be used as the substrate 1. Further, the liquid crystal molecules 3 may be stuck on either or both sides of the substrate 1 at least by a coating means, a spraying means, a dripping means, or the like, so that the liquid crystal molecules 3 are oriented properly.

Another existing layer having an optical function or action may be used as the substrate 1. That is, an optical filter layer or a semiconductor layer may be used as the substrate 1.

Examples of the liquid crystal constituted by the liquid crystal molecules 3 include: a compound having a photo- or thermo-crosslinkable group at a molecule terminal; low-molecular liquid crystal; discotheque liquid crystal; chiral crystal; and so on.

In the optical low-pass filter shown in each of FIGS. 1A to 1D, only one liquid crystal layer removed from the substrate 1 may be used as the filter. In such a case, the substrate 1 is used as a mold for determining the shape of the optical low-pass filter.

A CCD image pick-up apparatus is now taken as an example of an image pick-up apparatus using the optical low-pass filter shown in each of FIGS. 1A to 1D. A liquid crystal compound is provided on a transparent cover of glass for covering a light-input portion of a general CCD image pick-up device so that the average optical axis is oriented at a predetermined angle with respect to a surface of the cover in accordance with the liquid crystal compound shown in each of FIGS. 1A to 1D. The liquid crystal compound is then cured by light, heat, or the like. When the thickness of the cured film of the liquid crystal compound is preferably set to be about tens of micrometers, sufficient characteristic of the optical low-pass filter can be provided.

By the aforementioned configuration, space in front of the CCD image pick-up apparatus, necessary for the background art-type optical low-pass filter, can be almost eliminated. Accordingly, the greater reduction of the size of the image pick-up apparatus can be achieved.

According to one aspect of the process for production of the image pick-up apparatus, a cured film of a liquid crystal compound in accordance with the liquid crystal compound shown in each of FIGS. 1A to 1D is formed on the transparent cover of a CCD image pick-up device for covering a light-input portion of the CCD image pick-up device.

According to another aspect of the producing process, a cured film of a liquid crystal compound as a unit is formed on a substrate before the unit is disposed on a transparent cover of a CCD image pick-up device. As a modified example thereof, the unit per se may be disposed as a transparent cover directly on a light-input portion of the CCD image pick-up device.

Examples of the present invention will be described below with reference to the drawings.

First Example

In this example, an optical low-pass filter was formed as follows. SE-150 made by Nissan Chemical Industries, Ltd. was applied onto a glass substrate by a spin coating means. After SE-150 was then baked at 250° C. for an hour, liquid crystal ZLI-1132 made by Merk Inc. was dripped onto a rubbed oriented film and left for 30 minutes.

The filter thus obtained through the aforementioned process was placed between a resolution chart and an objective lens of a microscope, and then a chart image was observed with a transmission microscope. As a result, a double image was observed.

The double image was changed to a single image when a polarizing plate was inserted in the microscope in the direction of orientation of liquid crystal or in a direction perpendicular to the direction of orientation of liquid crystal. Accordingly, it was confirmed that the double image was actually constituted by an ordinary light image and an extraordinary light image. The distance between the two images was measured to be about 10 μm. Further, the thickness of the liquid crystal layer formed by the aforementioned process was about 80 μm.

Second Example

In this example, an optical low-pass filter was formed as follows. SE-150 made by Nissan Chemical Industries, Ltd. was applied onto a glass substrate by a spin coating means. After SE-150 was then baked at 250° C. for an hour, a tolan-type low-molecular liquid crystal compound having vinyl groups at opposite terminals and a polymerization initiator were dripped onto a rubbed oriented film and left for 30 minutes. Then, light from a mercury lamp was radiated onto the liquid crystal compound so that a liquid crystal high-molecular film can be obtained.

The filter thus obtained through the aforementioned process was placed between a resolution chart and an objective lens of a microscope, and then a chart image was observed with a transmission microscope. As a result, a double image was observed.

As means for forming the oriented film, an optical orientation means using polarized UV radiation, an orientation means using sputtering, a flow orientation means using shearing stress, an orientation means using oblique vapor deposition of inorganic matter, all orientation means used for orientation of liquid crystal, etc. as well as the orientation means using rubbing after application of a high-molecular film of polyimide, PVA, or the like, and the perpendicular orientation means using a silane coupling agent, can be used in combination suitably.

Further, as the means for vaporizing the liquid crystal deposited on the oriented film, a UV radiation means, a heating means, etc. as well as the means of leaving the liquid crystal at the room temperature, can be used.

As described above, according to the present invention, it is possible to provide an optical low-pass filter having optical characteristic equivalent to that of crystal and having a thickness equal to or smaller than 1/10 of the thickness of crystal. Furthermore, it is possible to provide a simple and low-cost method for producing the optical low-pass filter.

Further, it is possible to provide a large-area optical low-pass filter having optical characteristic equivalent to that of crystal and having a thickness no less than 1/10 of the thickness of crystal. Furthermore, it is possible to provide a simple and low-cost method for producing the optical low-pass filter.

In addition, it is possible to provide a CCD image pick-up apparatus integrated with the optical low-pass filter of crystal. Accordingly, not only both size and weight of the optical filter for an image pick-up apparatus, an OA appliance, or the like, can be reduced but also the greater reduction of the cost for production of the optical filter can be achieved.

What is claimed is:

1. An optical low-pass filter comprising a cured film of a liquid crystal compound having an average optical axis oriented at a predetermined angle with respect to a boundary surface.

2. An optical low-pass filter according to claim 1, wherein said cured film of said liquid crystal compound is formed, as a film having a thickness no less than 10 μm, on a transparent substrate or between a pair of the transparent substrates.

3. An optical low-pass filter according to claim 1, wherein said cured film of said liquid crystal compound is formed, as a film having a thickness no less than 10 μm, on a semitransparent substrate or between a pair of said semitransparent substrates.

4. An optical low-pass filter according to claim 1-3, wherein said liquid crystal compound is formed by use of a compound having a photo- or thermo-crosslinkable group at a molecule terminal.

5. A method for producing an optical low-pass filter, comprising the steps of:
forming an oriented film having a predetermined orientation form on a transparent substrate;
depositing a liquid crystal compound as a film having a thickness no less than 10 μm onto said transparent substrate or between a pair of said transparent substrates; and
curing said deposited liquid crystal compound while keeping it birefringent to thereby produce a cured-film optical low-pass filter.

6. A method for producing an optical low-pass filter, comprising the steps of:
forming an oriented film having a predetermined orientation form on a semitransparent substrate;
depositing a liquid crystal compound as a film having a thickness no less than 10 μm onto said semitransparent substrate or between a pair of semitransparent substrates; and
curing said deposited liquid crystal compound while keeping it birefringent to thereby produce a cured-film optical low-pass filter.

7. An image pick-up apparatus comprising: a matrix image pick-up device; a transparent cover covering a light-input portion of said image pick-up device; and a cured film of a liquid crystal compound disposed on said transparent cover so that an average optical axis is oriented at a predetermined angle with respect to a boundary surface of said transparent cover.

8. An image pick-up apparatus according to claim 7, wherein said cured film of said liquid crystal compound is provided, as a film having a thickness no less than 10 μm, on said transparent cover.

9. An image pick-up apparatus according to claim 7-8, wherein said liquid crystal compound is formed by use of a compound having a photo- or thermo-crosslinkable group at a molecule terminal.

10. A method for producing an image pick-up apparatus, comprising the step of forming a cured film of a liquid crystal compound on a transparent cover covering a light-input portion of a matrix image pick-up device in the condition that an average optical axis is oriented at a predetermined angle with respect to a boundary surface of said transparent cover.

11. A method for producing an image pick-up apparatus, comprising the step of: forming a cured film of a liquid crystal compound on a transparent cover in the condition that an average optical axis is oriented at a predetermined angle with respect to a boundary surface of said transparent cover, wherein said transparent cover is disposed in a light-input portion of a matrix image pick-up device.
